(19) United States
(12) Patent Application Publication
(10) Pub. No.: US 2008/0186112 A1
(43) Pub. Date: Aug. 7, 2008

(54) PACKAGE STRUCTURE FOR A HIGH-FREQUENCY ELECTRONIC COMPONENT

(76) Inventor: Eiichi HASE, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/961,106

(22) Filed: Dec. 20, 2007

(30) Foreign Application Priority Data
Dec. 25, 2006 (JP) 2006-347377

(51) Int. Cl. H01P 1/00

(52) U.S. Cl. 333/247

(57) ABSTRACT

A package structure having a recessed portion for accommodating an electronic component for inputting and outputting high-frequency signals such as a semiconductor device while preventing unwanted resonance and increases in loss of the high-frequency signals. Transmission lines for inputting and outputting high-frequency signals to and from the electronic component are formed on a dielectric substrate. Electrode lines for grounding are formed over the dielectric substrate adjacently to the transmission lines. The front ends of the electrode lines for grounding which face the recessed portion are connected with a metal enclosure for grounding via conductors in through-holes.

### INCORPORATION BY REFERENCE

The present application claims priority from Japanese application JP2006-347377 filed on Dec. 25, 2006, the content of which is hereby incorporated by reference into this application.

### BACKGROUND OF THE INVENTION

The present invention relates to a structure for packaging an electronic component such as a semiconductor device for inputting and outputting high-frequency signals and, more particularly, to a package structure having a recessed portion holding an electronic component therein. The recessed portion is formed on the surface of a conductor for grounding, by being surrounded by a dielectric member.

In package structures for high-frequency electronic components used in mobile wireless terminals and image transmission devices employed at microwave frequencies or higher, miniaturization and airtightness of the high-frequency package structures and use of still higher frequencies have become important factors from viewpoints of mountability and simplicity.

A structure having a metal enclosure for grounding (conductor for grounding) and a multilayered dielectric substrate formed on the surface of the enclosure is known as a first example of a conventional high-frequency package structure used in mobile wireless terminals and image transmission devices which are operated at microwave frequencies or higher. Transmission lines for inputting and outputting high-frequency signals to and from an electronic component are formed on the dielectric substrate. Thus, a distributed constant element is built (see, Microwave Application Lab.: “RF and Microwave Packaging Technology”, Dielectric Laboratories, March 2003).

In this example, a recessed portion in the form of a cavity structure for receiving an electronic component is formed in the multilayered dielectric substrate disposed on the surface of the metal enclosure for grounding. Also, the transmission lines are formed on the substrate. The distributed constant element is formed up to the end surfaces of the recessed portion in the form of the cavity structure by making use of the transmission lines. Thus, high-frequency signals are transmitted to the installed electronic component.

Similarly, a structure having a metal enclosure for grounding (conductor for grounding), a multilayered dielectric substrate formed on the surface of the enclosure, and transmission lines and metal electrodes for grounding formed on the substrate is known as a second example of the conventional structure using a metal enclosure for grounding and a multilayered dielectric substrate. The transmission lines and metal electrodes for grounding are used to input and output high-frequency signals to and from an electronic component. Thus, a distributed constant element is formed (see, Microwave Application Lab.: “RF and Microwave Packaging Technology”, Dielectric Laboratories, March 2003).

In this example, a recessed portion in the form of a cavity structure for receiving an electronic component is formed in the multilayered dielectric substrate disposed on the surface of the metal enclosure for grounding. Also, the transmission lines and the metal electrodes for grounding are formed on the substrate. A distributed constant element is formed using the transmission lines up to the end surfaces of the recessed portion in the form of the cavity structure, the transmission lines having the metal electrodes for grounding on the same surface. In this way, high-frequency signals are transmitted to the installed electronic component.

### SUMMARY OF THE INVENTION

The conventional structures described above have the advantage that high-frequency signals can be transferred up to the end surfaces of the recessed portion in the form of a cavity structure for receiving the installed electronic component owing to the dielectric substrate forming the distributed constant element utilizing the transmission lines or up to the end surfaces of the hole formed by the cavity structure that receives the installed electronic component. In addition, they have the advantage that the structure of the distributed constant element utilizing the transmission lines is simple and thus the size can be reduced.

In the first example of the above-described conventional techniques, the dielectric substrate having two or more layers is used. The dielectric substrate on which the distributed constant element is formed by the transmission lines cooperates with the transmission lines for transmitting high-frequency signals to form the distributed constant element up to the end surfaces of the recessed portion in the form of the cavity structure for receiving the installed electronic component or up to the end surfaces of the hole formed by the cavity structure for receiving the installed parts including a semiconductor device.

In this structure, the distributed constant element relying on the transmission lines having no electrodes for grounding on the same surface of the dielectric substrate is used. Radiation of high-frequency signals from the distributed constant element into free space may increase, thus increasing loss of the high-frequency signals, the distributed constant element being formed by the transmission lines formed on the surface of the dielectric substrate.

In the second example of the above-described conventional techniques, the dielectric substrate having two or more layers is used. The metal electrodes for grounding and transmission lines are formed on the same surface of the dielectric substrate. The dielectric substrate forms the distributed constant element up to the end surfaces of the recessed portion in the form of the cavity structure for receiving the electronic component or up to the end surfaces of the hole formed by the cavity structure for receiving the electronic component, utilizing the transmission lines for transferring high-frequency signals.

In this structure, the distributed constant element is formed by the transmission lines that forms the metal electrodes for grounding on the same surface of the dielectric substrate. If the metal electrodes for grounding are connected with the metal enclosure for grounding (conductor for grounding) via through-holes, the distributed constant element formed by each transmission line whose one side is open is left at the front ends of the through-holes. This may increase loss of high-frequency signals.

FIG. 10 shows a package structure for a high-frequency electronic component corresponding to the second example of the above-described prior art.

The package structure uses two layers of dielectric substrates 101 and 102. Metal electrodes 107 for grounding and transmission lines 106 are formed on the same surface of the substrate 101 and cooperate to form a distributed constant element. The substrate 101 cooperates with the transmission lines 106 for transferring high-frequency signals to form the distributed constant element up to the end surfaces of the recessed portion in the form of a cavity structure for receiving the installed electronic component.

Referring still to FIG. 10, there are shown the first layer of dielectric substrate 101 forming the distributed constant element together with the transmission lines 106, the second layer of dielectric substrate 102, a metal enclosure 103 for grounding, a pair of metal electrodes 107 for grounding, a hole (hollow space or compartment) 104 forming a cavity structure in the first layer of dielectric substrate 102, and a hole (hollow space or compartment) 105 forming a cavity structure in the second layer of dielectric substrate 102. The electrodes 107 are formed on the same surface of the dielectric substrate 101 on the opposite sides and adjacent to the transmission lines 106. The metal electrodes 107 for grounding are connected with the metal enclosure 103 for grounding via conductive through-holes 108.

The base ends (ends on the outer side of the package) of the conductive transmission lines 106 and metal electrodes 107 for grounding are exposed by cutouts 109 formed in the second layer of dielectric substrate 102 and can be connected with the outside. The installed electronic component is received in the recessed portion of the cavity structure formed by the holes 104 and 105. The transmission lines 106 are connected with the electronic component by wiring bonding.

The structure of FIG. 10 has the advantage that it can be reduced in size because the distributed constant element utilizing the transmission lines 106 is simple in structure. In addition, the transmission lines 106 are made to extend such that their front ends face the recessed portion of the cavity structure. Therefore, there is the further advantage that high-frequency signals can be transmitted by the transmission lines 106 up to the end surfaces of the hole 104 of the cavity structure accommodating the electronic component.

However, the metal electrodes 107 for grounding have their central portions connected with the metal enclosure for grounding via the conductive through-holes 108. Consequently, distributed constant elements formed by the portions b-c and e-f of the transmission lines 106 remain present which have open ends on the sides of the metal electrodes 107 which are closer to the front ends than the through-holes 108. This may increase losses in resonance and high-frequency signals.

FIG. 11 shows the transmission characteristics of the sections a-c and d-f of the example shown in FIG. 10. Similarly, FIG. 12 shows the reflection characteristics of the sections a-c and d-f.

As can be seen from FIG. 11, there is an unwanted resonance at about 26 GHz. It is observed that the transmission loss rapidly increases. As is obvious from FIG. 12, there is an unwanted resonance at about 26 GHz. It can be seen that the reflection characteristics are deteriorated and the resonance level is reduced to about −11 dB.

The characteristics shown in FIGS. 11 and 12 were obtained from the example shown in FIG. 10 in a measurement performed under the following conditions: the first layer of dielectric substrate 101 and the second layer of dielectric substrate 102 had a relative dielectric constant of 5.6 and a thickness of 0.15 mm; the metal conductor of the distributed constant element utilizing the transmission lines 106 had a width of 0.22 mm; the metal conductor of the metal electrodes 107 for grounding had a width of 0.8 mm; the conductive through-holes 108 had a diameter of 0.2 mm; the transmission line 106 left between each conductive through-hole 108 and the hole 104 of the cavity structure had a length of 1.2 mm; the dielectric substrates 101, 102 and the metal enclosure 103 for grounding measured 10×8 mm; the metal enclosure 103 for grounding had a thickness of 0.6 mm; the hole 104 formed in the dielectric substrate 101 measured 4.8×3.2 mm; the hole 105 of the cavity structure formed in the dielectric substrate 102 measured 7.2×5.6 mm; and the cutouts 109 formed in the second layer of dielectric substrate 102 for inputting and outputting high-frequency signals to and from the outside measured 2.4×0.6 mm.

The present invention has been made in view of the foregoing circumstances in the prior art. It is an object of the present invention to provide a package structure which is for use with an electronic component for inputting and outputting high-frequency signals such as a semiconductor device and which prevents unwanted resonance and increases in loss of high-frequency signals.

A package structure according to one aspect of the present invention has an electric conductor for grounding and a recessed portion formed over the surface of the conductor and surrounded by a dielectric member, the recessed portion holding an electric component therein. Transmission lines (traces) for inputting and outputting high-frequency signals to and from the electronic component are formed on the dielectric member. Electrode lines (traces) for grounding are formed on the dielectric member and along the transmission lines adjacently to both sides of each transmission line. The front ends of the electrode lines for grounding which face the recessed portion are electrically connected with the conductor for grounding.

Preferably, the connection between the front ends of the grounding electrode lines facing the recessed portion and the conductor for grounding is made by electrical connection members deposited on the end surface of the dielectric member facing the recessed portion, the electrical connection members including metal conductors.

In another feature of the present invention, the electrode lines for grounding have intermediate portions extending from the base ends (ends on the outside of the package) to their front ends and the intermediate portions are connected with the conductor for grounding via conductive through-holes extending through the dielectric member.

In a further feature of the invention, another dielectric member or members are formed over the aforementioned dielectric member on which transmission lines and electrode lines for grounding are formed, thus forming a multilayered structure of dielectric members.

In the present invention, the dielectric member on which the transmission lines and electrode lines for grounding are formed may be a single-layered or multilayered member. The structure of the dielectric member can be selected arbitrary according to design requirements.

Furthermore, in the present invention, the electric conductor for grounding is a metal body (i.e., metal enclosure for grounding) as in the above example. Alternatively, the conductor may be a member consisting of a dielectric substrate to which electrical conductivity is imparted by coating the surface of the substrate with a metal. In summary, any member designed to serve grounding purposes may be adopted.

Moreover, the invention can be applied to package structures for various electronic components including semiconductor devices and devices acting as filters for inputting and outputting high-frequency signals.

Additionally, in the present invention, various materials including glass and ceramics can be used as the material of the dielectric member.

A package structure in which an electronic component is hermetically accommodated can be easily accomplished by covering the recessed portion in the cavity structure accommodating the electronic component with the dielectric substrate.

According to the present invention, the electrode lines for grounding are connected at their front ends facing the recessed portion with the conductor for grounding, the electrode lines for grounding being formed adjacently to the transmission lines. Therefore, the front ends of the electrode lines for grounding formed on the dielectric member are prevented from being opened. Hence, increases in losses of resonance and high-frequency signals can be prevented.

Furthermore, according to the present invention, the electrode lines for grounding are connected at their intermediate portions with the conductor for grounding via the conductive through-holes extending through the dielectric member. Consequently, increases in losses of resonance and high-frequency signals can be prevented more effectively.

Moreover, according to the present invention, a further dielectric member or members are formed over the aforementioned dielectric member on which the transmission lines and electrode lines for grounding are formed. Thus, a multilayered structure of dielectric members is formed. Therefore, a package structure which is based on the prior art structure, i.e., multilayered structure of dielectric substrates, but which can prevent increases in losses of resonance and high-frequency signals can be accomplished.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view of a package structure for a high-frequency electronic component, the package structure being associated with a first embodiment of the present invention.

FIG. 2 is a cross-sectional view taken along line II-II of FIG. 10, showing main portions of the package structure for a high-frequency electronic component, the package structure being associated with the first embodiment of the invention.

FIG. 3 is a perspective view of the package structure for a high-frequency electronic component, the package structure being associated with the first embodiment of the invention.

FIG. 4 is a diagram showing the transmission characteristics of the high-frequency package associated with the first embodiment of the invention.

FIG. 5 is a diagram showing the reflection characteristics of the high-frequency package structure associated with the first embodiment of the invention.

FIG. 6 is a perspective view of a package structure for a high-frequency electronic component, the package structure being associated with a second embodiment of the invention.

FIG. 7 is a cross-sectional view taken along line VII-VII of FIG. 6, showing main portions of the package structure for a high-frequency electronic component, the package structure being associated with the second embodiment of the invention.

FIG. 8 is a perspective view of a package structure for a high-frequency electronic component, the package structure being associated with a third embodiment of the invention.

FIG. 9 is a cross-sectional view taken along line IX-IX of FIG. 8, showing main structures of the package structure for a high-frequency electronic component, the package structure being associated with the third embodiment of the invention.

FIG. 10 is a perspective view of a prior-art package structure for a high-frequency electronic component.

FIG. 11 is a diagram showing the transmission characteristics of the prior art high-frequency package structure.

FIG. 12 is a diagram showing the reflection characteristics of the prior art high-frequency package structure.

FIG. 13 is a perspective view useful in illustrating a method of fabricating the package structure for a high-frequency electronic component, the package structure being associated with the first embodiment of the invention.

FIG. 14 is another perspective view useful in illustrating a method of fabricating the package structure for a high-frequency electronic component, the package structure being associated with the first embodiment of the invention.

FIG. 15 is a further perspective view useful in illustrating a method of fabricating the package structure for a high-frequency electronic component, the package structure being associated with the first embodiment of the invention.

### DESCRIPTION OF THE EMBODIMENTS

The present invention is described in detail based on its embodiments by referring to the drawings. Like components are indicated by like reference numerals.

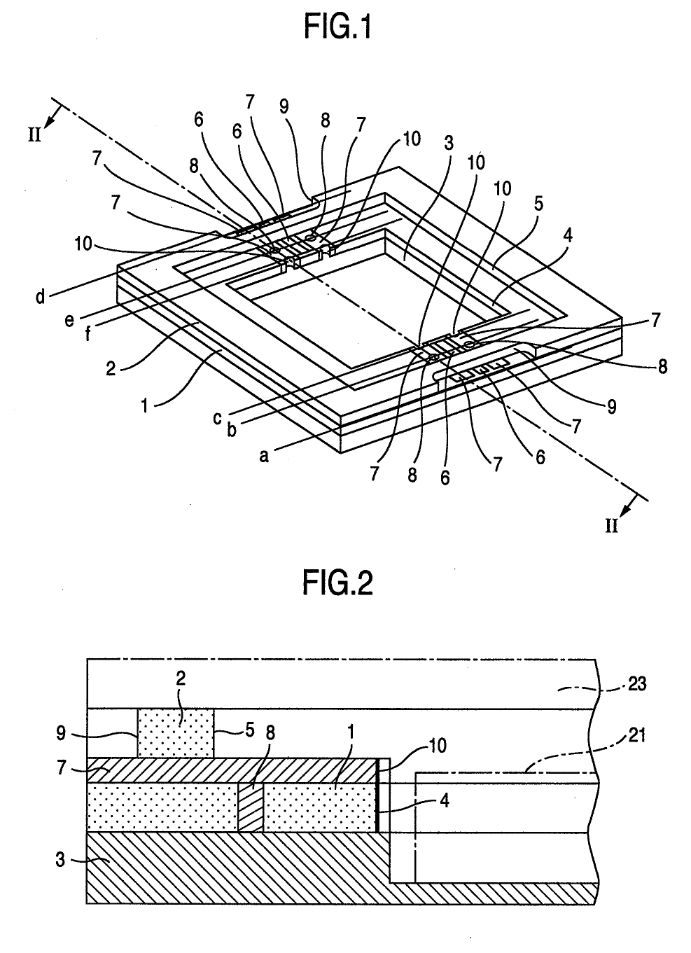

FIG. 1 shows a package structure for a high-frequency electronic component, the package structure being associated with a first embodiment of the present invention. FIG. 2 shows a cross-sectional structure of one of electrode lines 7 for grounding.

In the embodiments described below, a dielectric substrate is used as a dielectric member. A metal enclosure for grounding or a dielectric substrate coated with a metal is used as an electric conductor for grounding.

In FIGS. 1 and 2, a first layer of dielectric substrate 1 is provided with a hole (hollow space or compartment) 4 of a cavity structure. The hole 4 accommodates an electronic component 21. Conductive transmission lines (traces) 6 and a pair of electrode lines (traces) 7 for grounding which together form a distributed constant element are formed on the top surface of the dielectric substrate 1. A metal enclosure 3 for grounding is formed on the bottom surface of the dielectric substrate 1, thus forming a bottom surface for the hole 4. A second layer of dielectric substrate 2 having a hole (hollow space or compartment) 5 of a cavity structure is formed over the dielectric substrate 1.

That is, a recessed portion of the cavity structure is formed. The bottom surface of the cavity structure is formed by the metal enclosure 3 for grounding. The inner wall surfaces of the cavity structure are defined by the holes 4 and 5. The transmission lines 6 and a pair of electrode lines 7 for grounding extend on the dielectric substrate 1. The electrode lines 7 are adjacent to the transmission lines 6. The front ends of the transmission lines 6 and electrode lines 7 for grounding face the recessed portion of the cavity structure.

Furthermore, through-holes 8 are formed in the dielectric substrate 1 and filled with conductors such as a metal to form conductive through-holes 8. Each electrode line 7 for grounding is connected in its central portion with the metal enclosure 3 for grounding. Semicylindrical through-holes 10 are formed in the wall surface of the hole 4. A conductor such as a metal is formed on the inner surface of each through-hole 10 to form a semicylindrical conductive through-hole 10. Each electrode line 7 for grounding is connected at its front end with the metal enclosure 3 for grounding.

That is, the electrode lines 7 for grounding are formed on the same surface as the transmission lines 6 on the dielectric substrate 1. Each electrode line 7 has an intermediate portion extending from its base end to the front end. The intermediate portions of the electrode lines 7 for grounding are connected with the metal enclosure 3 for grounding via the conductive through-holes 8. The electrode lines 7 are also connected at their front ends with the metal enclosure 3 for grounding via the conductive through-holes 10, the front ends facing the recessed portion.

It is also possible to connect the electrode lines 7 for grounding with the metal enclosure 3 for grounding via the conductive through-holes 10 without forming the conductive through-holes 8. A method of forming the through-holes 10 having the conductors therein is described later.

The second layer of dielectric substrate 2 is provided with cutouts 9 so that high-frequency signals are taken to the outside from the transmission lines 6 or high-frequency signals are received into the transmission lines 6 from the outside. Consequently, the transmission lines 6 and the base ends of the electrode lines 7 for grounding are exposed.

FIG. 3 shows an example of mounting of the package structure for a high-frequency electronic component, the package structure being associated with the first embodiment of the invention.

The electronic component 21 is accommodated in the recessed portion of the cavity structure formed by the hole 4. The electronic component 21 and the front ends of the transmission lines 6 are connected by bonding wires 22.

The package structure holding the electronic component 21 therein can be made hermetic by providing a cover 23 over the recessed portion, the cover 23 being made either of a dielectric substrate to which conductivity is imparted or of a metal plate having the same dimensions as the second layer of dielectric substrate 2.

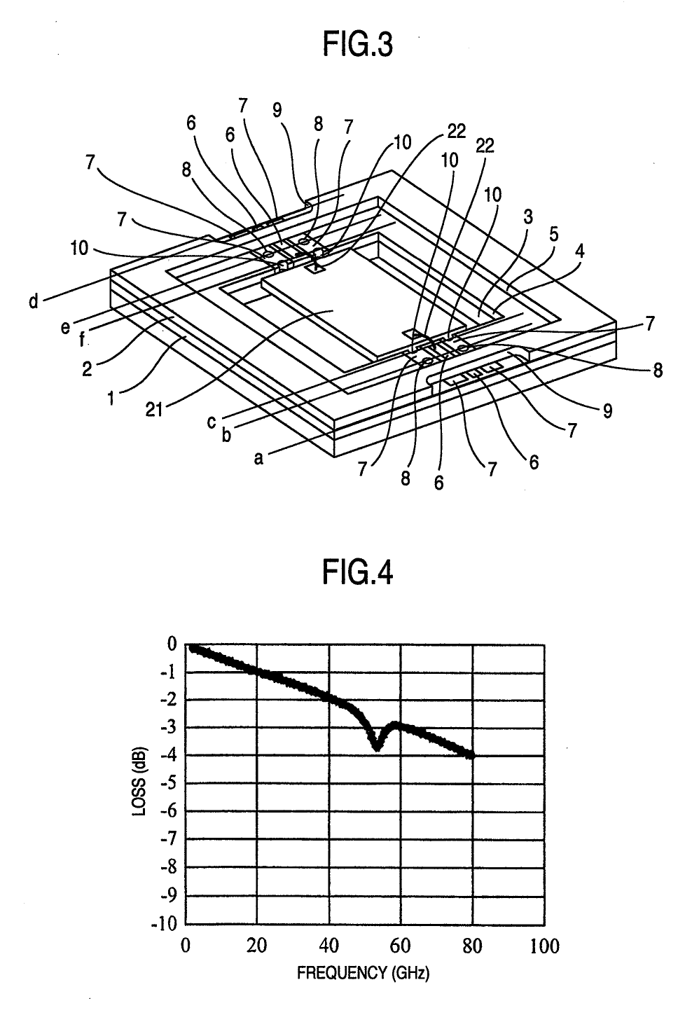

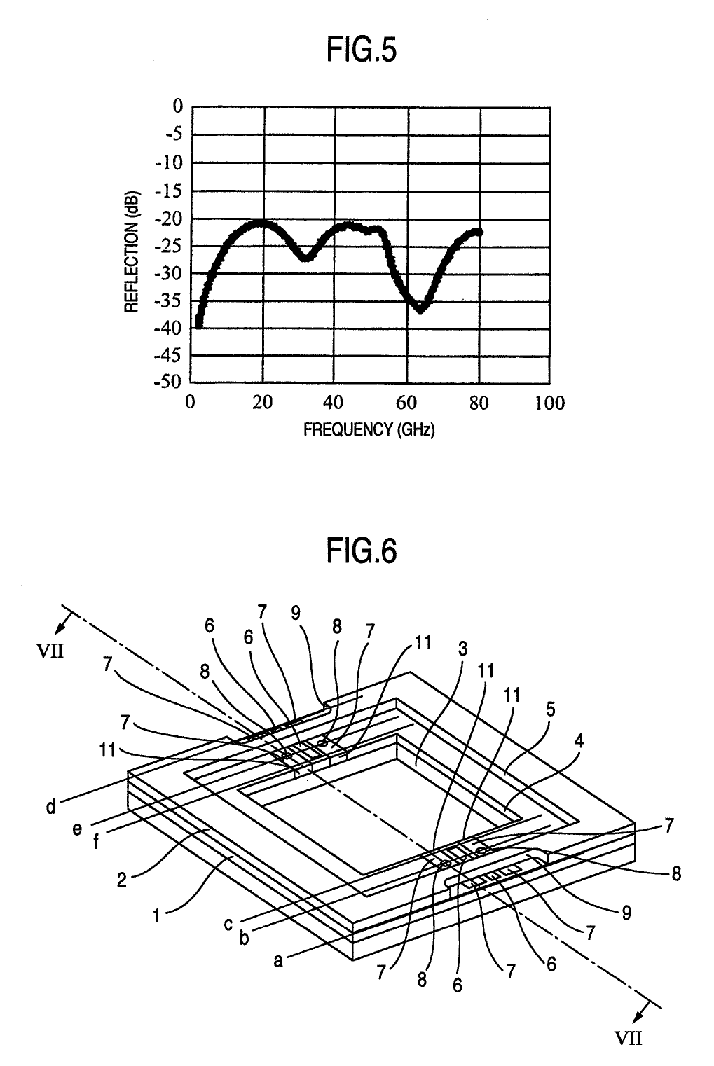

FIG. 4 shows the transmission characteristics of the sections a-c and d-f of the example shown in FIG. 1. Similarly, FIG. 5 shows the reflection characteristics of the sections a-c and d-f.

It can be seen from FIG. 4 that there is no unwanted resonance from DC to 45 GHz. It can be seen from FIG. 5 that there is no unwanted resonance from DC to 45 GHz and that the reflection characteristics are such that the loss is less than −20 dB.

The characteristics shown in FIGS. 4 and 5 were obtained from the example shown in FIG. 1 in a measurement performed under the following conditions: the first layer of dielectric substrate 1 and the second dielectric substrate 2 had a relative dielectric constant of 5.6 and a thickness of 0.15 mm; the metal conductor trace of the distributed constant element utilizing the transmission lines 6 had a width of 0.22 mm; the metal conductor trace of the metal electrodes 7 for grounding had a width of 0.8 mm; the conductive through-holes 8 connecting the electrode lines 7 for grounding and the metal enclosure 3 for grounding had a diameter of 0.2 mm; the conductive through-holes 10 connecting the electrode lines 7 for grounding and the metal enclosure 3 for grounding had a diameter of 0.2 mm; the dielectric substrates 1, 2 and the metal enclosure 3 for grounding measured 10×8 mm; the metal enclosure 3 for grounding had a thickness of 0.6 mm; the hole 104 formed in the dielectric substrate 1 measured 4.8×3.2 mm; the hole 5 formed in the second layer of dielectric substrate 2 measured 7.2×5.6 mm; and the cutouts 9 formed in the dielectric substrate 2 measured 2.4×0.6 mm.

In the first embodiment described above, the second layer of dielectric substrate 2 having the hole 5 of the cavity structure is laminated on the upper surface of the first layer of dielectric substrate 1 having the hole 4 of the cavity structure. The metal enclosure 3 for grounding is placed at a lower position. The holes are covered with the metal plate or dielectric substrate to which electrical conductivity is imparted. Thus, a two-layered structure of dielectric substrates is formed. For example, at least one third dielectric substrate that is similar to either the first layer of dielectric substrate 1 or the second layer of dielectric substrate 2 may be placed between the first layer of dielectric substrate 1 and the second layer of dielectric substrate 2 to form three or more layers of dielectric substrates. In the present invention, the number of layers of dielectric substrates is not limited.

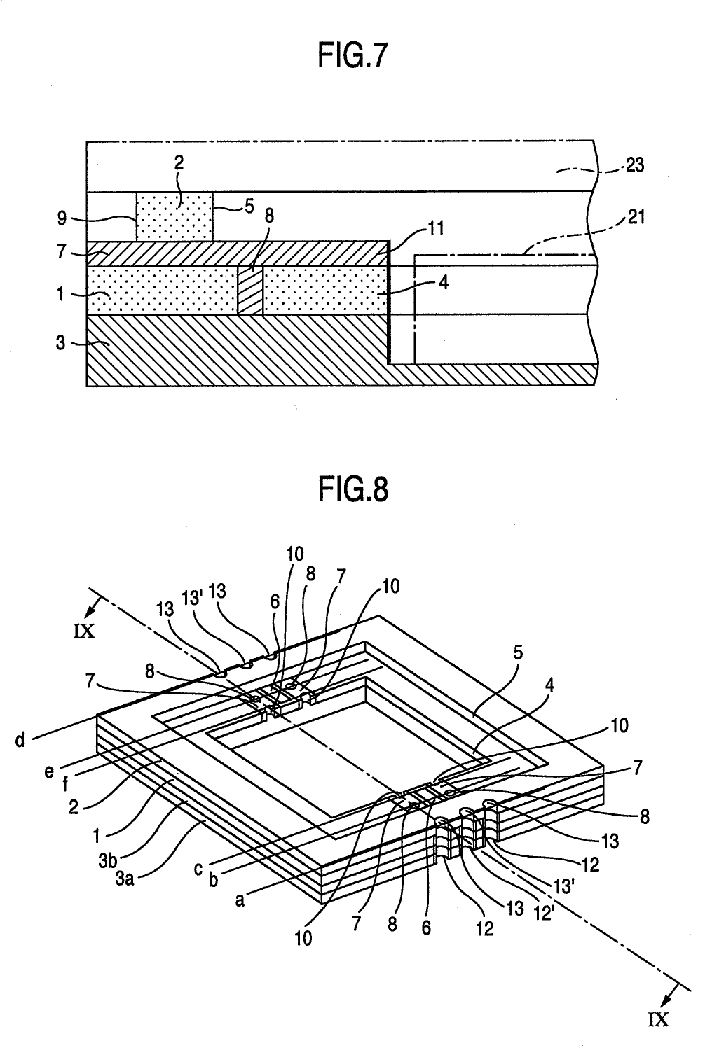

FIG. 6 shows a package structure for a high-frequency electronic component, the package structure being associated with a second embodiment of the present invention. FIG. 7 shows a cross-sectional structure of one of electrode lines 7 for grounding. Those components of the second embodiment which are identical with their counterparts of the first embodiment are indicated by the same reference numerals as in the first embodiment. Description of those components which have been already described will not be made below.

The package structure for use with a high-frequency electronic component and built according to the second embodiment is similar to the package structure associated with the first embodiment except that the electrode lines 7 for grounding are connected at their front ends with the metal enclosure 3 for grounding by the metal conductors 11 in the form of a flat plate instead of use of the semicylindrical through-holes 10 of the first embodiment.

That is, the metal conductors 11 in the form of a flat plate are mounted on the inner wall surface of the dielectric substrate 1. The front end of each electrode line 7 for grounding that faces the recessed portion in the cavity structure accommodating the electronic component 21 is connected with the metal enclosure 3 for grounding.

Thus, in the second embodiment as well, the electrode lines 7 for grounding are connected at their intermediate portions with the metal enclosure 3 for grounding via the conductive through-holes 8, the intermediate portions extending from the base ends of the electrode lines 7 to the front ends and the electrode lines 7 are also connected at their front ends with the metal enclosure 3 for grounding by the metal conductors 11. Alternatively, it is also possible to connect the electrode lines 7 for grounding with the metal enclosure 3 for grounding by the metal conductors 11 without forming the conductive through-holes 8.

The transmission characteristics of the sections a-c and d-f (FIG. 6) of the package structure according to the second embodiment are similar to the transmission characteristics (FIG. 4) of the package structure according to the first embodiment. Similarly, the reflection characteristics of the sections a-c and d-f are similar to the reflection characteristics (FIG. 5) of the package structure according to the first embodiment.

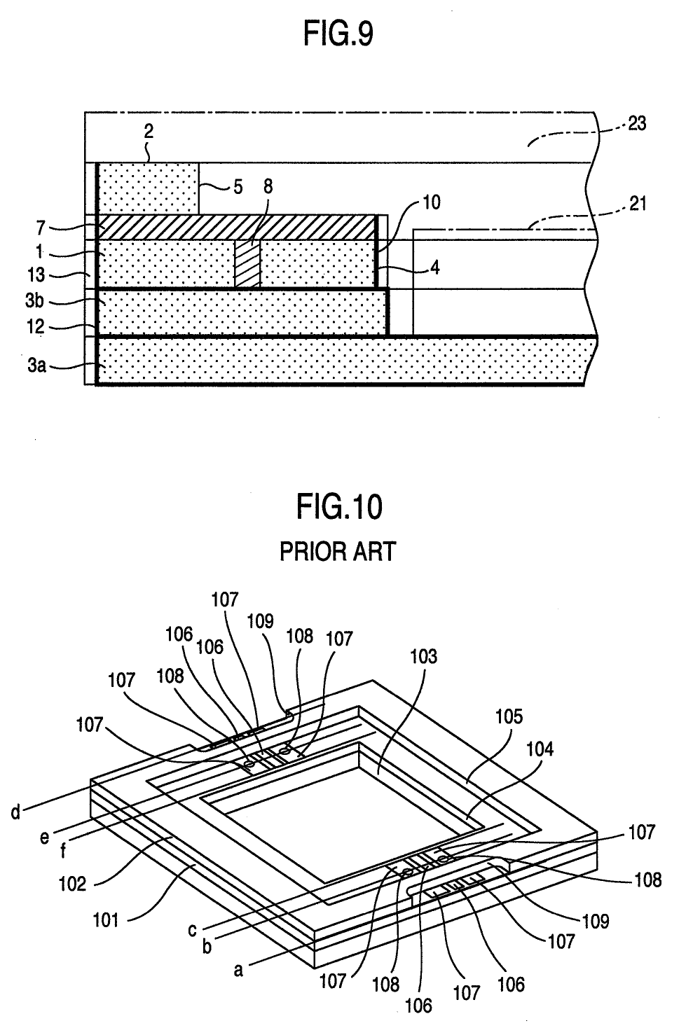

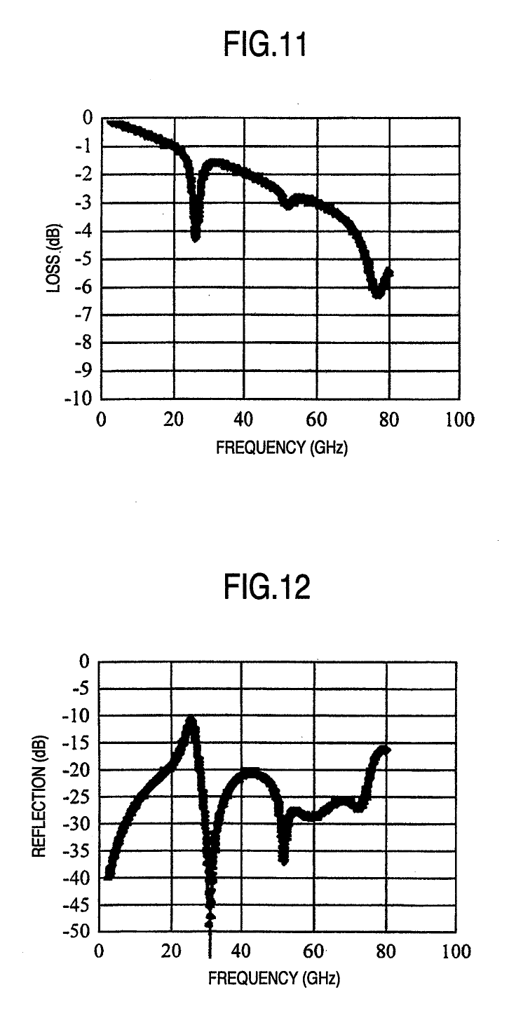

FIG. 8 shows a package structure for a high-frequency electronic component, the package structure being associated with a third embodiment of the present invention. FIG. 9 shows a cross-sectional structure of one of electrode lines 7 for grounding. Those components of the third embodiment which are identical with their counterparts of the first embodiment are indicated by the same reference numerals as in the first embodiment. Those components which have been already described will not be described below.

In the package structure associated with the third embodiment and used with the high-frequency electronic component, the metal enclosure 3 of the first embodiment for grounding is made of two layers of dielectric substrates 3a and 3b. A metal for grounding is deposited over the whole surface of each of the substrates 3a and 3b.

That is, the dielectric substrate 3b forming the second layer and having the cavity identical in size with the hole 4 is mounted over the dielectric substrate 3a forming the first layer. The dielectric substrate 1 forming the third layer and the dielectric substrate 2 forming the fourth layer are mounted over the dielectric substrate 3b. Thus, a multilayered structure is formed. Grounding surfaces are formed by a metal deposited on the dielectric substrates 3a and 3b.

In the package structure for use with a high-frequency electronic component and built according to the third embodiment, the hole formed in the second layer of dielectric substrate 3b cooperates with the hole 4 formed in the third layer of dielectric substrate 1 to form a recessed portion of the cavity structure for accommodating the electronic component 21.

In the third embodiment, the front ends of the electrode lines 7 for grounding formed on the dielectric substrate 1 and facing the recessed portion are connected with the metal surface on the second layer of dielectric substrate 3b through the semicylindrical through-holes 10. Consequently, the front ends of the electrode lines 7 for grounding are connected with the grounding surface consisting of two layers of dielectric substrates 3a and 3b which are totally deposited with metal in their entirety.

Furthermore, in the third embodiment, to take out a high-frequency signal to the outside or accepting the signal, semicylindrical through-holes 13 and 13′ are formed in (i) the dielectric substrate 3a forming the first layer, (ii) the dielectric substrate 3b forming the second layer, (iii) the dielectric substrate 1 forming the third layer, and (iv) the dielectric substrate 2 forming the fourth layer. Conductors 12 and 12′ are deposited on the inner wall surfaces of the through-holes 13 and 13′ extending through the dielectric substrates 3a, 3b, and 1 forming the first, second, and third layers, respectively. As a result, the conductor 6 forming a distributed constant element utilizing the transmission lines and the electrode lines 7 for grounding are exposed at the rear surface of the first layer of dielectric substrate 3a. With this structure, a leadless package structure is accomplished. The through-holes 13′ having the conductor 12′ therein are used for transmission lines 6. The portions of the metal layer for grounding formed on the two layers of dielectric substrates 3a and 3b which would otherwise make contact with the through-holes 13′ need to be previously cut out to avoid shorting to the grounding metal.

In the third embodiment as well, the electrode lines 7 for grounding are connected at their intermediate portions with the grounding surfaces 3a and 3b via the conductors in the through-holes 8. The intermediate portions extend from the base ends of the electrode lines 7 to the front ends. The electrode lines 7 are also connected at their front ends with the grounding surfaces 3a and 3b via the conductive through-holes 10. Alternatively, the electrode lines 7 for grounding may be connected with the grounding surfaces 3a and 3b via the conductive through-holes 10 without forming the conductive through-holes 8.

In the package structure according to the third embodiment, the transmission characteristics of the sections a-c and d-f of FIG. 8 are similar to the reflection characteristics (FIG. 4) of the first embodiment. Similarly, the reflection characteristics of the sections a-c and d-f are similar to the reflection characteristics (FIG. 5) of the first embodiment.

The package structure according to the third embodiment can also be made hermetic by providing a cover made either of a dielectric substrate to which electrical conductivity is imparted or of a metal plate having the same dimensions as the fourth layer of dielectric substrate 2.

Furthermore, in the third embodiment, grounding metal is deposited to the whole surface of each of the first layer of dielectric substrate 3a and second layer of dielectric substrate 3b, and these substrates 3a and 3b are placed at lower positions. The fourth layer of dielectric substrate 2 having the hole 5 of the cavity structure is placed over the upper surface of the third layer of dielectric substrate 1 having the hole 4 in the cavity structure. A cover is provided by a metal plate or a dielectric substrate to which electrical conductivity is imparted. Thus, a four-layered dielectric substrates is formed. However, in the present invention, the number of layers of dielectric substrates is not limited. For example, a further dielectric substrate or substrates similar to the dielectric substrate 1 or 2 can be interposed between the third layer of dielectric substrate 1 and the fourth layer of dielectric substrate 2 to form five or more layers.

Main portions of a process for fabricating the package structure associated with the first embodiment of the present invention illustrated in FIG. 1 are next described, the package structure being for use with a high-frequency electronic component. The process itself is a conventional technique but it is necessary to meet some requirements including assurance of sufficient strength of the metal conductors formed in the semicylindrical through-holes, easiness with which position of the deposition are set, and easiness of the deposition of the metal conductors.

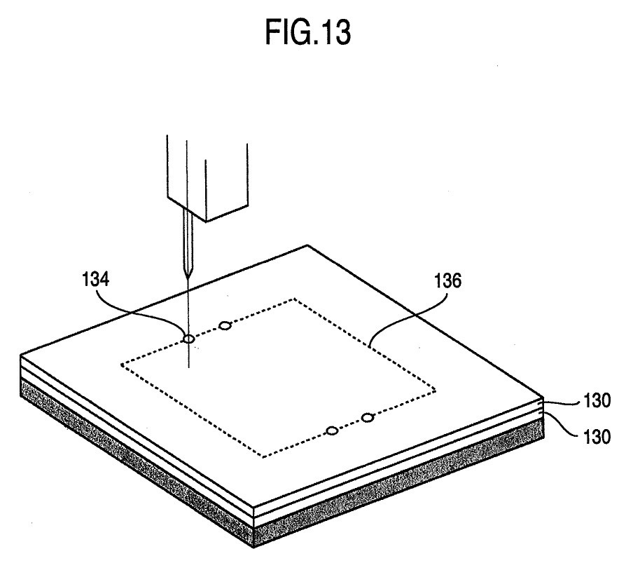

First, as shown in FIG. 13, plural holes 134 are drilled in one or more stacked, uncured soft dielectric substrates 130 (before sintering) with a drilling machine 132 to form the through-holes. Typically, the dielectric substrates are made of a ceramic material having a relative dielectric constant ∈ᵣ of 8 to 10 or a glass-ceramic material having a relative dielectric constant ∈ᵣ of 4.5 to 8. Note that the material of the dielectric substrates is not limited to these materials.

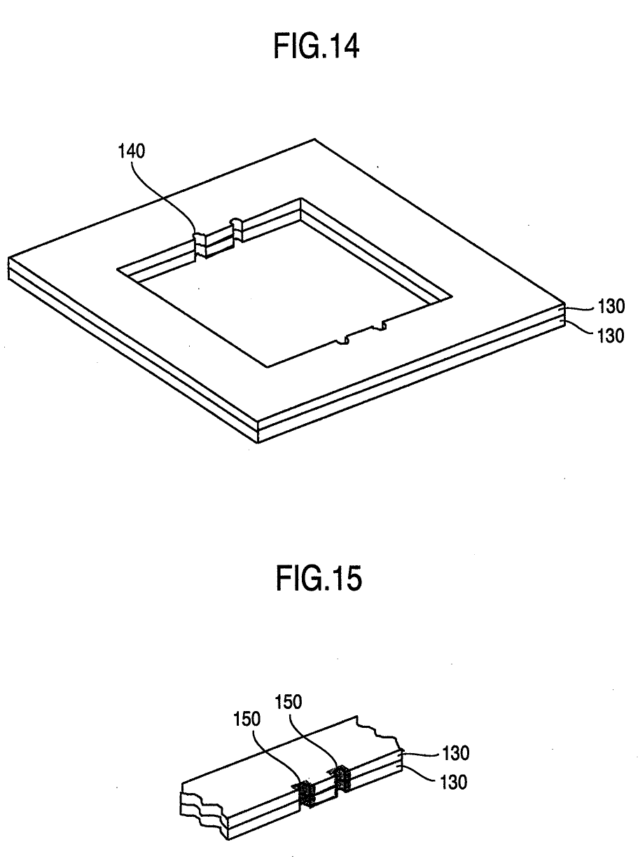

Then, central portions of the dielectric substrates indicated by the broken lines 136 in FIG. 13 are stamed out with a press machine to form a recessed portion of the cavity structure for accommodating an electronic component. As a result of this press work, the soft dielectric substrate 130 in which the hole 140 becoming the semicylindrical through-hole shown in FIG. 14 is formed is fabricated. That is, the holes 140 for the through-holes are formed in the end surfaces facing the recessed portion in the dielectric substrate 130 for accommodating the electronic component. Then, as shown in FIG. 15, a metal conductor 150 is deposited into the holes 140 for the semicylindrical through-holes. At least one layer of dielectric substrate created in this way and a metal for grounding are stacked on top of each other and sintered. Consequently, the metal conductor 150 in the hole 140 for the through-hole and the metal 3 for grounding (FIG. 1) are connected together. As a result, a package structure according to the present invention is fabricated. The steps of the above-described process is not always limited to the aforementioned order. Further, the metal for grounding may be a dielectric substrate with a metal conductor deposited thereon.

The metal conductor deposited in the holes for the semicylindrical through-holes provides necessary strength. In the above-described process, the through-holes are created by drilling. The plural holes for the through-holes may be created at a time using rectangular punching teeth. Also, in this case, it is possible that the deposited metal conductor has necessary strength.

The metal conductor 11 in the form of a flat plate of the embodiment illustrated in FIG. 6 can also be fabricated by deposition of the metal conductor although it is necessary to pay attention to the positioning and assurance of the required strength.

It should be further understood by those skilled in the art that although the foregoing description has been made on embodiments of the invention, the invention is not limited thereto and various changes and modifications may be made without departing from the spirit of the invention and the scope of the appended claims.

1. A package structure for a high-frequency electronic component, said package structure comprising:
a conductive surface for grounding;
a recessed portion formed over the conductive surface and surrounded by a dielectric member, the recessed portion being adapted to accommodate the electronic component;
transmission lines formed on the dielectric member and inputting and outputting high-frequency signals to and from the electronic component;
a pair of electrode lines for grounding, the electrode lines being formed on the dielectric member adjacently to the transmission lines; and
electrical connections which connect each of front ends of the electrode lines facing the recessed portion with the conductor for grounding.

2. A package structure as set forth in claim 1, wherein said electrode lines for grounding are connected at their intermediate portions with said conductor for grounding via conductive through-holes, the through-holes extending through the dielectric member, said intermediate portions extending from said front ends to opposite ends.

3. A package structure as set forth in claim 1, wherein one or more further dielectric members are mounted over said dielectric member on which the transmission lines and the electrode lines for grounding are formed, whereby the package structure is made of multiple layers of dielectric members.

4. A package structure as set forth in claim 2, wherein one or more further dielectric members are mounted over said dielectric member on which the transmission lines and the electrode lines for grounding are formed, whereby the package structure is made of multiple layers of dielectric members.

5. A package structure as set forth in claim 1, wherein said pair of electrode lines for grounding includes two electrodes for grounding, the two electrodes being formed on both sides, one for one side, of an associated transmission line.

6. A package structure as set forth in claim 1, wherein the front ends of said electrode lines for grounding facing recessed portion side extend up to end surfaces of said dielectric member facing said recessed portion side, and wherein said front ends are electrically connected with said conductor for grounding immediately under said end surfaces of the dielectric member on a side of the recessed portion by said electrical connection.

7. A package structure as set forth in claim 6, wherein said electrical connection includes a metal conductor deposited on the end surface of said dielectric member on a side of said recessed portion.

8. A package structure as set forth in claim 6, wherein said electrical connection includes conductive semicylindrical through-holes formed in the end surface of the dielectric member on a side of said recessed portion.
